(19) United States
(12) Patent Application Publication
(10) Pub. No.: US 2015/0100685 A1
(43) Pub. Date: Apr. 9, 2015

(54) APPARATUS AND METHOD FOR SUPPORTING INTRA-CLOUD AND INTER-CLOUD EXPANSION OF SERVICE

(71) Applicant: Electronics and Telecommunications Research Institute, Daejeon-city (KR)

(72) Inventors: Dongjae KANG, Daejeon (KR); Namwoo KIM, Daejeon (KR); Jinmee KIM, Daejeon (KR); Sungin JUNG, Daejeon (KR)

(73) Assignee: Electronics and Telecommunications Research Institute, Daejeon-city (KR)

(21) Appl. No.: 14/456,371

(22) Filed: Aug. 11, 2014

(30) Foreign Application Priority Data
Oct. 4, 2013 (KR) 10-2013-0118527

(51) Int. Cl. H04L 12/24

(52) U.S. Cl. CPC H04L 41/5003
USPC 709/224

(57) ABSTRACT

An apparatus and method for supporting the expansion of cloud service are disclosed. The apparatus for supporting expansion of cloud service includes a service expansion management unit, and a service image management unit. The service expansion management unit requests the running of a service registered in a source cloud, and determines whether the expansion of service is required by monitoring the running service. The service image management unit acquires the one or more service images of the service whose expansion is determined to be required by the service expansion management unit from a service image database (DB), and registers the service images in a target cloud.

### CROSS-REFERENCE TO RELATED APPLICATION

This application claims the benefit of Korean Patent Application No. 10-2013-0118527, filed Oct. 4, 2013, which is hereby incorporated by reference herein in its entirety.

### BACKGROUND OF THE INVENTION

1. Technical Field

The present disclosure relates to cloud computing technology and, more particularly, to an apparatus and method that support the intra-cloud and inter-cloud expansion of service in order to distribute the load of an application service in a virtual system-based multi-cloud environment.

2. Description of the Related Art

With the advancement of cloud computing technology, clouds have been newly established in various areas of the world and existing clouds have been expanded, and thus cloud service has continued to expand. In line with the proliferation of cloud service, Internet application service has become diversified, large-scaled and complicated, and application service providers have taken various measures for the maintenance of Quality of Service (QoS) in response to an increasing number of service users.

Currently, Internet application service generally uses a method of constructing the same service server within a single Internet data center (IDC) or cloud and allowing a load distribution administrator to distribute service requests among service servers in order to mitigate a delay of service in a running service attributable to excessive user connections or lack of computing resources. Furthermore, Korean Patent Application Publication No. 10-2012-0072241 discloses a system for moving an individual virtual machine in a cloud computing environment and a method thereof.

However, although these methods have the effect of mitigating delay of service to a specific level through an increase in computing resources, such as a central processing unit (CPU) and memory, they are disadvantageous in that it is difficult to distribute a load attributable to requests for service from a large number of service users among network resources and an improvement in delay of service attributable to the geometrical separation of a large number of increasing remote users is limited. Furthermore, in the case of a service in which the number of service users explosively increases, such as a Social Network Service (SNS), the inter-cloud expansion of service as well as intra-cloud expansion of service is required in order to enable the expansion of service to various areas while overcoming geometrical limitations and mitigate the delay of service for a number of continuously increasing remote users.

### SUMMARY OF THE INVENTION

Accordingly, at least one embodiment of the present invention is intended to provide an apparatus and method that support the intra-cloud and inter-cloud expansion of service in order to distribute the load of an operating virtual system-based service system.

In accordance with an aspect of the present invention, there is provided an apparatus for supporting the expansion of cloud service, including a service expansion management unit configured to request running of a service registered in a source cloud, and to determine whether expansion of service is required by monitoring the running service; and a service image management unit configured to acquire the one or more service images of the service whose expansion is determined to be required by the service expansion management unit from a service image database (DB), and to register the service images in a target cloud.

The apparatus may further include a load distribution agent previously installed in each service registered in the source cloud, and configured to transmit information about the running service to the service expansion management unit when the service is run.

The service expansion management unit may determine whether the expansion of service is required by monitoring system and resource states based on the information about the service received from the load distribution agent.

The service expansion management unit may determine a target cloud whose service will be expanded when the expansion of the service running in the source cloud is required.

When a request for a service is received from a service user, the service expansion management unit may select a service having the lowest service delay from among the services that provide the requested service and have been registered in the clouds, and may then provide information about the selected service to the service user.

When a request for registration of one or more service images is received from a service provider, the service image management unit may access the source cloud, may receive the service images of the requested service, and may store the received service images in the service image DB.

In accordance with another aspect of the present invention, there is provided a method of supporting the expansion of cloud service, including requesting running of a service registered in a source cloud; determining whether expansion of service is required by monitoring the running of the service; acquiring one or more service images of the service whose expansion is determined to be required from a service image DB; and registering the service images in a target cloud.

The method may further include, when the service runs in the source cloud in response to the request for running, registering information about the running service.

Determining whether the expansion of service is required may include determining whether the expansion of service is required by monitoring system and resource states based on the registered information about the service.

The method may further include, if, as a result of the determination, it is determined that the expansion of the service is required, determining a target cloud for the expansion of the service.

The method may further include receiving a request for a service from a service user; selecting a service having a lowest service delay from among the services that provide the requested service and have been registered in the clouds; and providing information about the selected service to the service user.

The method may further include receiving a request for registration of one or more service images of the service registered in the source cloud from a service provider; receiving the requested service images of the service from the source cloud; and storing the received service images in the service image DB.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates an example of a virtual system-based service system according to an embodiment of the present invention;

FIG. 2 is a block diagram of an apparatus for supporting the expansion of cloud service according to an embodiment of the present invention;

FIG. 3 is a diagram illustrating a procedure in which the load distribution management unit of FIG. 2 registers and monitors service images;

FIG. 4 is a diagram illustrating a procedure in which an apparatus for supporting the expansion of cloud service performs the expansion of service;

FIG. 5 is a diagram illustrating a procedure in which an apparatus for supporting the expansion of cloud service processes a service use request from a user;

FIG. 6 is a flowchart illustrating a method of supporting the expansion of cloud service according to an embodiment of the present invention;

FIG. 7 is a detailed flowchart illustrating the procedure of registering and monitoring service images in the method of supporting the expansion of cloud service illustrated in FIG. 6;

FIG. 8 is a detailed flowchart illustrating the procedure of performing the expansion of service in the method of supporting the expansion of cloud service illustrated in FIG. 6; and

FIG. 9 is a detailed flowchart illustrating the procedure of processing a request for the use of a service from a user in the method of supporting the expansion of cloud service illustrated in FIG. 6.

### DESCRIPTION OF THE PREFERRED EMBODIMENTS

Reference now should be made to the drawings, throughout which the same reference numerals are used to designate the same or similar components.

An apparatus and method for supporting the expansion of cloud service according to embodiments of the present invention will be described with reference to the accompanying diagrams.

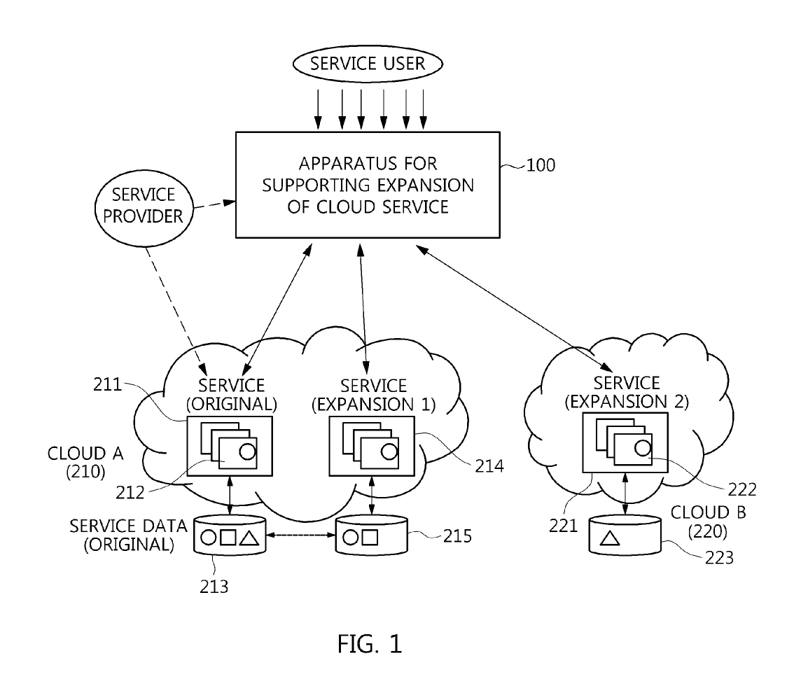

FIG. 1 illustrates an example of a virtual system-based service system according to an embodiment of the present invention.

Referring to FIG. 1, one or more virtual service images 212 are installed in an original service 211 registered in a basic cloud A 210 in response to a request from a service provider. When the expansion of the original service 211 is required, an apparatus 100 for supporting the expansion of cloud service may provide an expansion service 214 through the expansion of service within the same cloud A 210, and may provide an expansion service 221 through the expansion of service to another cloud B 220.

As illustrated in FIG. 1, the apparatus 100 for supporting the expansion of cloud service according to an embodiment of the present invention may be remotely separate from services within clouds, and may support the intra-cloud or inter-cloud expansion of service.

In this case, the original service 211 registered in the cloud A 210 before the expansion of the service and a service data storage 213 may be remotely connected to each other, and service data may be accessed from the outside using authenticated connection information.

Furthermore, expansion services 214 and 221 are configured such that connection information used for connection to the service data storage is recorded in advance in virtual service images that are generated for the expansion of service. When the expansion services 214 and 221 run, the expansion services 214 and 221 connect to respective pieces of corresponding data storage using the recorded connection information.

Once the virtual service images 212 related to the original service 211 have been registered in the cloud A 210, a service provider connects to the apparatus 100 for supporting the expansion of cloud service, and requests the registration and management of the virtual service images 212 registered in the cloud A 210. The apparatus 100 for supporting the expansion of cloud service connects to the cloud A 210 in response to a request from the service provider, receives the virtual service images 212 of the corresponding original service 211 from the cloud A 210, and then registers and manages them in a service image storage (not illustrated).

The apparatus 100 for supporting the expansion of cloud service monitors the original service registered in the cloud A 210, and, if the expansion of service is required because of a delay of service, selects a service expansion-target cloud between the cloud A 210 in which the original service has been registered or the other cloud B 220 and expands service in the selected cloud, illustrated as FIG. 1.

Thereafter, when a user connects to the apparatus 100 for supporting the expansion of cloud service and requests the use of service, the apparatus 100 for supporting the expansion of cloud service selects a service that belongs to the original service and the expansion service and has the smallest load or is closest to the location of the user, and transmits information about the corresponding service to a user terminal. Then the user connects to the service using the information, and uses service.

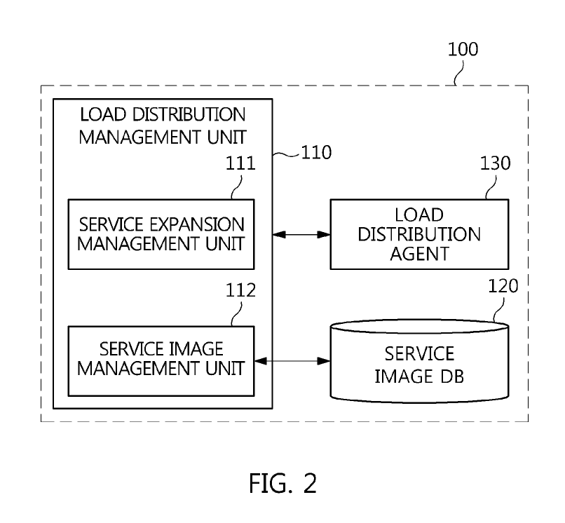

FIG. 2 is a block diagram of an apparatus for supporting the expansion of cloud service according to an embodiment of the present invention.

Referring to FIG. 2, the apparatus 100 for supporting the expansion of cloud service may include a load distribution management unit 110, a service image DB 120, and a load distribution agent 130.

The load distribution management unit 110 registers and manages the virtual service images of service registered in a source cloud in the service image DB 120 in response to a request from a service provider, monitors whether the expansion of service is required, and, if the expansion of service is required because of a delay of service, transmits corresponding images selected from among the managed virtual service images to a target cloud, so that they are registered in the target cloud.

Meanwhile, as illustrated in FIG. 2, in greater detail, the load distribution management unit 110 may include a service expansion management unit 111 and a service image management unit 112.

The service expansion management unit 111 requests a source cloud to run a service registered by the service provider, and determines whether the expansion of service is required by monitoring the resource state of the running service and thus monitoring whether a delay of service has occurred.

When the service image management unit 110 receives information about a request for the management of virtual service images registered in the source cloud and related to a service from the service provider, the service image management unit 110 connects to the source cloud, and receives the service images of the requested service.

Thereafter, the service image management unit 110 stores the received service images in the service image DB 120.

Furthermore, if the service expansion management unit 111 determines that the expansion of a specific service running in a source cloud is required, the service image management unit 110 obtains service images related to the service from the service image DB 120, and transmits them to a target cloud, so that they are registered in the target cloud.

The load distribution agent 130 may be previously registered in the virtual service images of a service that is registered in a cloud. When the service is run in the cloud in response to a request from the service expansion management unit 111, the load distribution agent 130 transmits its own system information to the service expansion management unit 111.

In this case, the system information may include connection information that enables the service expansion management unit 111 to access a service in order to manage the service.

The service expansion management unit 111 may access the system for the service running in the cloud based on the connection information of the system information, may monitor system and resource states, and may determine whether the expansion of service is required.

If, as a result of the monitoring, it is determined that the expansion of service is required, the service expansion management unit 111 may determine a service expansion-target cloud. Whether to expand service within the source cloud or to another cloud may be determined using various information, such as the state of the overall system including the running source cloud and the other cloud and the locations of users who have requested the corresponding service.

For example, when the overall performance of the source cloud is insufficient, there is a high possibility of a delay of service in the corresponding cloud even when the expansion of service is performed, and thus another cloud may be determined to be the target cloud. Alternatively, when users who are densely populated in a specific area request the use of a corresponding service currently running in a source cloud, a cloud located closest to the users may be selected as the target cloud.

When a service user requests the use of a specific service, the service expansion management unit 111 may select any one of services for a cloud in which the requested service is running, that is, a source cloud, and a target cloud, and may transmit information about the system to a user terminal.

The user who has requested the use of the service accesses the corresponding service using the received system information, and then uses the corresponding service.

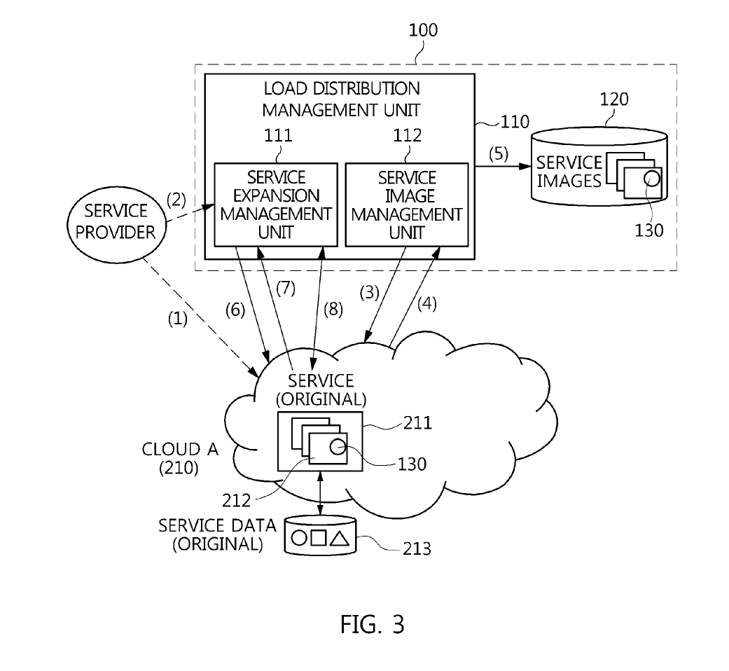

FIG. 3 is a diagram illustrating a procedure in which the load distribution management unit 110 of FIG. 2 registers and monitors service images.

Referring to FIG. 3, (1) a service provider accesses a cloud A 210 selected for the running of a service 211, requests a virtual system including required computing resources, and is assigned it. Thereafter, the service provider completes the installation of software and the setting of a configuration required for the provision of service in the assigned virtual system, and then registers one or more corresponding virtual service images in the cloud A 210.

(2) Thereafter, the service provider accesses the apparatus 100 for supporting the expansion of cloud service, and then requests the apparatus 100 for supporting the expansion of cloud service to manage the virtual service images 212 of the service 211 registered in the cloud A 210.

(3) Then, the service image management unit 112 accesses the load distribution management unit 110 of the cloud A 210, and requests the requested images of the virtual system; (4) when the cloud A 210 transmits the corresponding virtual service images to the service image management unit 112, (5) the service image management unit 112 stores received virtual service images in the service image DB 120.

(6) The service expansion management unit 111 requests the cloud A 210 to run the virtual service images 212 in order to run the service 211 registered in the cloud A 210. (7) When the virtual service images 212 are run in response to a request from the service expansion management unit 111, the previously installed load distribution agent 130 registers its system information by transmitting its system information to the service expansion management unit 111.

(8) The service expansion management unit 111 monitors system and resource states using the registered system information.

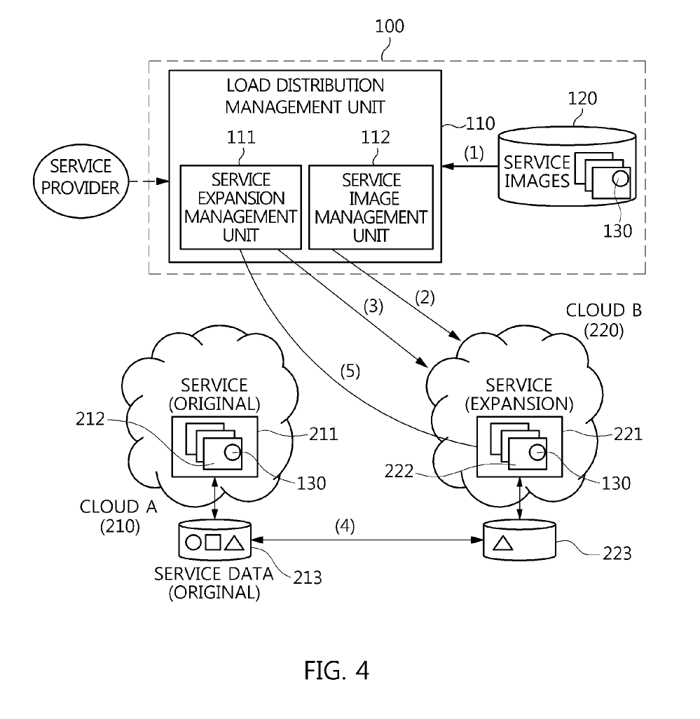

FIG. 4 is a diagram illustrating a procedure in which an apparatus for supporting the expansion of cloud service performs the expansion of service. FIG. 4 is a diagram illustrating the procedure of supporting the expansion of service between clouds when a delay of service occurs because requests for a service explosively increase or a plurality of remote users is using a service. Although the expansion of service between different clouds, that is, from a source cloud A 210 to a target cloud B 220, is described for ease of description, the present invention is not limited thereto, but the expansion of service may be performed in the source cloud A 210, as described above.

Referring to FIG. 4, (1) when the service expansion management unit 111 monitors the system and resource states of the service 211 running in the cloud A 210 and determines that the expansion of service is required, the service image management unit 112 acquires the virtual service images of a service requiring the expansion of service from a service image DB 120. (2) Thereafter, the service image management unit 112 registers the acquired virtual service images by transmitting the acquired virtual service images to the cloud B 220 requiring the expansion of service.

(3) The service expansion management unit 111 requests the running of the virtual system 222 of a service 221 registered in the cloud B 220. (4) The cloud B 220 runs the virtual system 222 of the service 221 in response to a request, and connects to data storage 223 using previously registered service data system information.

In this case, service data is not always moved from the data storage 213 of the source cloud 210 to the data storage 223 of the cloud B 220. When data required for the processing of a service request is present in the data storage 223 of the cloud B 220, service is processed using the data storage 223. If data is not present, corresponding data is requested from the data storage 213 of the source cloud A 210 and is stored in the data storage of the cloud B 220, and then the service request is processed.

As described above, whenever service data is required, it is determined whether the service data is present in the corresponding data storage 223, the service data is moved from the service data storage 213 of the source cloud A 210 only when the service data is not present, and then the service is processed, with the result that network load attributable to the transmission of data can be reduced.

(5) Thereafter, the load distribution agent 130 previously installed in the virtual service image 222 registered in the cloud B 220 registers its own system information by transmitting its own system information to the service expansion management unit 111.

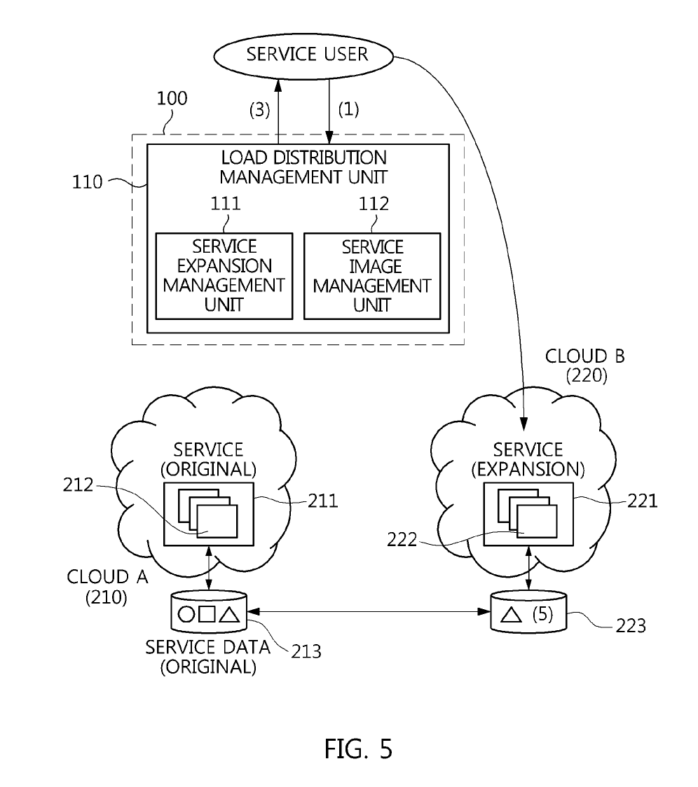

FIG. 5 is a diagram illustrating a procedure in which an apparatus for supporting the expansion of cloud service processes a request for the use of service from a user.

Referring to FIG. 5, in the state in which the virtual service images of a service has been transmitted to a target cloud B 220 by a service image management unit 112 and service has been expanded from a source cloud A 210 to the target cloud B 220, (1) when a user accesses the apparatus 100 for supporting the expansion of cloud service and requests the provision of a service, (2) the service expansion management unit 111 selects a virtual service that belongs to currently running services 211 and 221 and that also is determined to have the lowest service delay, for example, the service 221 of the cloud B 220, (3) and transmits information about the selected service 221 to a user terminal.

(4) The user who has requested the provision of the service accesses the virtual system of the corresponding cloud B 220 and then uses the service based on system information received through the user terminal. In this case, required service data is acquired from connected data storage 223, as described above, and required service data is requested from the service data storage 213 of the source cloud A 210 when the required service data is not present in the data storage 223.

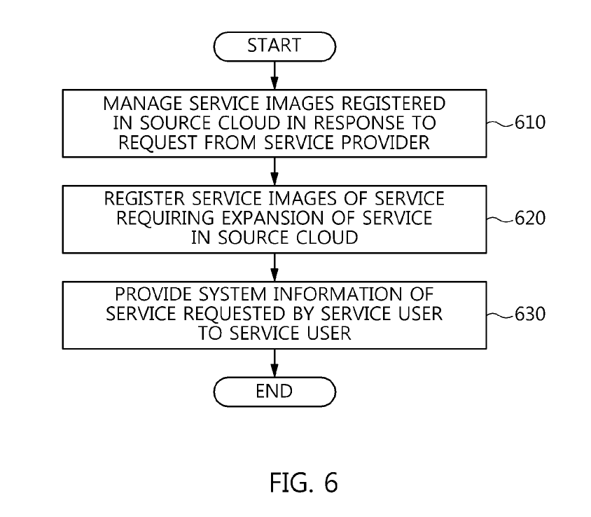

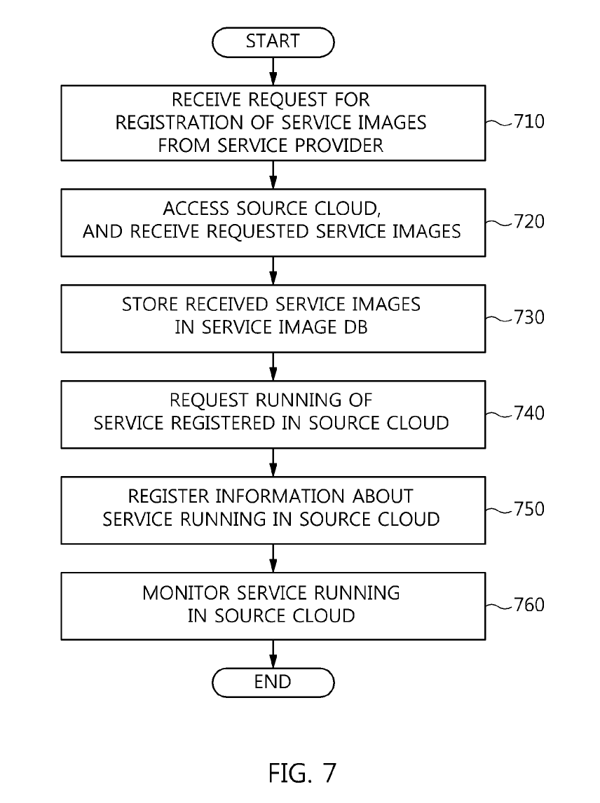

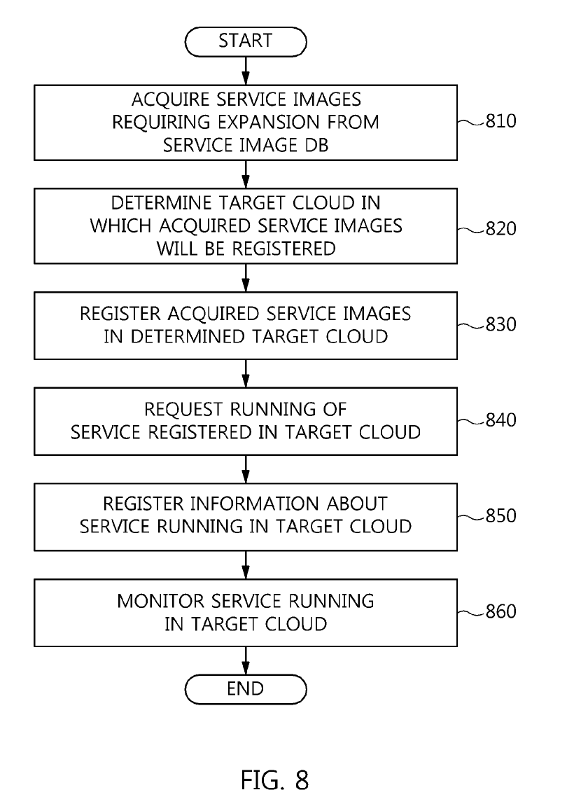

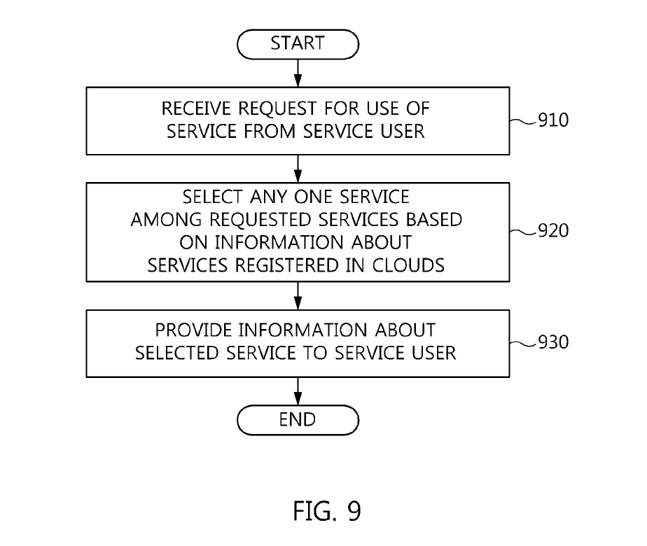

FIG. 6 is a flowchart illustrating a method of supporting the expansion of cloud service according to an embodiment of the present invention. FIG. 7 is a detailed flowchart illustrating the procedure of registering and monitoring service images in the method of supporting the expansion of cloud service illustrated in FIG. 6. FIG. 8 is a detailed flowchart illustrating the procedure of performing the expansion of service in the method of supporting the expansion of cloud service illustrated in FIG. 6. FIG. 9 is a detailed flowchart illustrating the procedure of processing a request for the use of a service from a user in the method of supporting the expansion of cloud service illustrated in FIG. 6.

The procedures of FIGS. 6 to 9 may be performed by the apparatus 100 for supporting the expansion of cloud service illustrated in FIG. 1. Since the operation of the apparatus 100 for supporting the expansion of cloud service has been described in detail with reference to FIGS. 1 to 5, redundant descriptions are omitted below.

Referring to FIG. 6, when a service provider makes a request, the apparatus 100 for supporting the expansion of cloud service receives and manages the virtual service images of a service registered in a source cloud at step 610.

The procedure of managing the virtual service images (step 610) is described in detail with reference to FIG. 7. The apparatus 100 for supporting the expansion of cloud service receives a request for the registration of service images registered in a source cloud from a service provider at step 710.

Thereafter, the source cloud is accessed in response to the request from the service provider and then a corresponding service-related virtual service images are received at step 720, and the received virtual service images are stored in a service image DB at step 730.

Thereafter, the running of a registered service is requested from the source cloud at step 740, and system information is received from a load distribution agent previously installed in the virtual service images registered in the source cloud and then registered at step 750.

Thereafter, whether the expansion of the running service is required is monitored based on information about the registered virtual system at step 760.

Referring back to FIG. 6, when the expansion of the service running in the source cloud is required, the virtual service images of the service are transmitted and registered in the target cloud at step 620.

The procedure of expanding a target cloud service (step 620) is described with reference to FIG. 8. First, service images requiring expansion are acquired from a service image DB at step 810.

Thereafter, a target cloud in which acquired service images are registered may be determined at step 820. A target cloud may be determined by reference to the state of the entire system including a source cloud and other clouds and the density of users who request the provision of service as described above.

Thereafter, once the target cloud has been determined at step 820, the acquired service images are registered in the determined target cloud at step 830.

Thereafter, the running of a service registered in the target cloud is requested at step 840, and information about the system is received from the load distribution agent and registered at step 850 once the service has been run in the target cloud.

Thereafter, the service running in the target cloud is monitored based on the registered information about the system at step 860.

Referring back to FIG. 6, when a service user accesses the apparatus 100 for supporting the expansion of cloud service and requests the use of a service, information about a system whose service delay is determined to be lowest based on the system state of a service running in each is provided to the service user at step 630.

The procedure of processing a request from a service user (step 630) is described in greater detail with reference to FIG. 9. First, a request for the use of a service is received from a service user at step 910.

Thereafter, any one service having the smallest service delay is selected based on the system information of a cloud in which the service requested by the user is running at step 920, and information about the selected service is transmitted to the terminal of the user at step 930. Once the information about the system of the requested service has been received, the user accesses the service via a terminal and uses the service.

In accordance with at least one embodiment of the present invention, a virtual system-based Internet service provider can rapidly perform the expansion of service to another cloud while overcoming the physical limitation of a specific cloud when a delay of service occurs because of requests for a service from users, and can provide proximate service to a plurality of increasing remote service users.

Furthermore, the inter-cloud expansion of service as well as intra-cloud expansion of service is supported, and thus a load can be distributed among not only computing resources, such as a CPU and memory, but also network resources.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for supporting expansion of cloud service, comprising:
a service expansion management unit configured to request running of a service registered in a source cloud, and to determine whether expansion of service is required by monitoring the running service; and
a service image management unit configured to acquire one or more service images of the service whose expansion is determined to be required by the service expansion management unit from a service image database (DB), and to register the service images in a target cloud.

2. The apparatus of claim 1, further comprising a load distribution agent previously installed in each service registered in the source cloud, and configured to transmit information about the running service to the service expansion management unit when the service is run.

3. The apparatus of claim 2, wherein the service expansion management unit determines whether the expansion of service is required by monitoring system and resource states based on the information about the service received from the load distribution agent.

4. The apparatus of claim 1, wherein the service expansion management unit determines a target cloud whose service will be expanded when expansion of the service running in the source cloud is required.

5. The apparatus of claim 1, wherein the service expansion management unit, when a request for a service is received from a service user, selects a service having a lowest service delay from among the services that provide the requested service and have been registered in the clouds, and then provides information about the selected service to the service user.

6. The apparatus of claim 1, wherein the service image management unit, when a request for registration of one or more service images is received from a service provider, accesses the source cloud, receives the service images of the requested service, and stores the received service images in the service image DB.

7. A method of supporting expansion of cloud service, comprising:
requesting running of a service registered in a source cloud;
determining whether expansion of service is required by monitoring the running of the service;
acquiring one or more service images of the service whose expansion is determined to be required from a service image DB; and
registering the service images in a target cloud.

8. The method of claim 7, further comprising, when the service runs in the source cloud in response to the request for running, registering information about the running service.

9. The method of claim 8, wherein determining whether the expansion of service is required comprises determining whether the expansion of service is required by monitoring system and resource states based on the registered information about the service.

10. The method of claim 7, further comprising, if, as a result of the determination, it is determined that the expansion of the service is required, determining a target cloud for the expansion of the service.

11. The method of claim 7, further comprising:
receiving a request for a service from a service user;
selecting a service having a lowest service delay from among the services that provide the requested service and have been registered in the clouds; and
providing information about the selected service to the service user.

12. The method of claim 7, further comprising:
receiving a request for registration of one or more service images of the service registered in the source cloud from a service provider;
receiving the requested service images of the service from the source cloud; and
storing the received service images in the service image DB.
